(19) United States
(12) Patent Application Publication
(10) Pub. No.: US 2010/0166180 A1
(43) Pub. Date: Jul. 1, 2010

(54) CLOAKING OF RADIO SIGNALS

(75) Inventors: David Steer, Nepean (CA); David Bevan, Bishops Stortford (GB); Simon Gale, Bishops Stortford (GB)

Correspondence Address: BARNES & THORNBURG LLP, P.O. BOX 2786, CHICAGO, IL, 60690-2786, US

(73) Assignee: Nortel Networks Limited, St. Laurent (CA)

(21) Appl. No.: 12/346,231

(22) Filed: Dec. 30, 2008

(51) Int. Cl. H04K 1/02

(52) U.S. Cl. 380/252; 380/270

(57) ABSTRACT

The present invention comprises a device that, based upon signals transmitted by devices within a wireless network, causes masking signals to be selectively transmitted. For example, the device may not cause masking signals to be transmitted if the signal does not include confidential data, for example it is an acknowledgement message. Additionally, the strength, coding rate and modulation format of the masking signals may be varied to provide increased data security.

### FIELD OF THE INVENTION

The invention relates to a method of masking a wireless communication network's signal outside the intended coverage region of the wireless communication network. The invention further relates to apparatus configured to transmit masking signals to mask data signals transmitted by a wireless communication network.

### BACKGROUND OF THE INVENTION

It often is desirable for users to protect data transmitted by a device within a wireless communications network, as the data can be confidential or commercially sensitive. In view of this, wireless communications network providers employ a number of methods to prevent access to data transmitted across their networks by any device that is not a part of the wireless network.

Conventionally, one, or a combination, of three methods is used by network providers to prevent access to data transmitted over a wireless communications network. These are: confining the coverage of the wireless communications network to a predefined region, encrypting the data and the use of jamming signals.

The confinement of signals transmitted by devices within a wireless communication network to a predefined region is often difficult to implement in practice. A wireless communications network can use two types of antenna to transmit signals including data: a directed or an undirected antenna. Directed antennas transmit signals in a particular direction; however, these antennas are typically large in size in order to obtain directionality. Additionally, as many devices use undirected antennas it is uneconomical in most networks to convert all the undirected antennas to directed antennas. Furthermore, radio signals will reflect off surfaces such as walls and windows, which will cause them to propagate outside the intended coverage region.

Signals transmitted by undirected antennas can also be confined to a predefined region by restricting the strength of signals transmitted by the antennas and/or by setting up interference patterns. However, as with directed antennas, reflection can cause signal leakage. Thus, it is often difficult to confine signals to a predefined region with signals often leaking from the region.

Data may be encrypted using an encryption key in order to prevent the data being accessed by devices that are outside a network, or are not authorised to access the data. The encryption method requires that both parties, the sender of the data and the intended receiver, possess a key to enable encryption and decryption of the data. A user receiving encrypted data would find it difficult to decode the encrypted data without access to the encryption key. However, it is potentially possible for users to decode an encrypted signal by performing suitable analysis on the signal or discovering the key.

Finally, access to data transmitted by devices within a wireless network may be restricted through the transmission of jamming signals, such as a signal containing randomized data. The jamming signals are transmitted outside the intended coverage region of the wireless network such that much of the radio spectrum contains the jamming signals. Thus, users outside the intended coverage region only receive noise and are not able to access the data. However, as the jamming signal occupies much of the radio spectrum, and not just the portion being used by the wireless communications network, it will also interfere with transmissions between devices outside the intended coverage region.

Therefore, it is desirable to find an improved method of protecting the data transmitted over a wireless communications network.

### SUMMARY OF THE INVENTION

According to a first aspect of the present invention there is provided a method of masking a signal outside an intended coverage region of a wireless network, the signal being transmitted by a device within the wireless network, the method comprising the steps of: determining a property of the signal; determining, from the property, whether to transmit a masking signal; and upon determining to transmit a masking signal, transmitting a masking signal outside the intended coverage region.

The step of determining a property of the signal may comprise determining if the signal was transmitted by a device within the wireless network and the method comprises transmitting a masking signal if the device is in the wireless network. This means that only the signals transmitted by the wireless network are subject to masking decreasing the disruption to communications outside the wireless network.

Optionally, the step of determining if the signal was transmitted by a device in the wireless network may include determining the MAC address of a packet in the signal and comparing the determined MAC address to the MAC addresses of devices in the network.

The step of determining a property of the signal may include determining if the type of packet within the signal and the step of determining, from the property, whether to transmit a masking signal comprises determining whether the type of packet is to be masked. This means that only signals including data of any significance are masked and data such as ACK messages are not masked thereby decreasing the amount of disruption to communications outside the wireless network.

Optionally, the step of determining a property of the signal may include determining the strength of the signal and the step of determining if masking signal is to be transmitted comprises the step of comparing the strength of the signal to a threshold; the masking signal being transmitted if the strength of the signal is above the threshold. This means that signals which are too weak to be propagated outside the intended coverage region of the wireless network are not subject to a masking signal.

Further, the method may include the steps of determining the strength of the signal and setting the strength of the masking signal to be greater than that of the signal.

Advantageously the masking signal is transmitted in a frequency range such that the frequency range of the masking signal substantially overlaps with the frequency range of the signal. This means that only the frequency range utilised by the wireless network is subject to interference from the masking signal and that devices outside the intended coverage region of the wireless network can communicate over frequency ranges not utilised by the wireless network without interference from the masking signal.

Preferably, the masking signal is transmitted for a time duration such that the time duration of the masking signal substantially overlaps with the time duration of the transmission of the signal. This means that devices outside the intended coverage region of the wireless network can use the frequency of the wireless network when devices within the wireless network are not transmitting signals. This increases the amount of bandwidth available to devices outside the wireless network. Optionally, this may be implemented by detecting a header of a packet within the signal, determining the length of the packet from the header and causing a packet within the masking signal to have a corresponding length to the packet within the signal.

Advantageously, the method includes determining the coding rate of a packet within the signal and setting the coding rate of a masking packet within the masking signal to be one of the group comprising: a lower coding rate than the coding rate of the packet; and a coding rate randomly selected from a set of coding rates. By setting the coding rate of a packet within the masking signal to be lower than that of one in the signal the probability of a user outside the intended coverage region attempting to access data in the masking packet rather than in the data packet is increased. By selecting a coding rate randomly, it decreases the likelihood of a user outside the intended coverage region filtering out the masking packet through the coding rate being known.

The method may include the step of comparing the coding rate of the masking packet to the coding rate of the packet; and, if the coding rate of the masking packet is equal to or greater than the coding rate of the packet masking, causing the strength of the masking signal to be greater than the strength of the signal. By increasing the strength of the masking signal when the coding rates are the same the probability of a user outside the intended coverage region attempting to access data in the masking packet rather than in the data packet is increased.

Further, the method may include the steps of: determining the modulation format of a packet within the signal and setting modulation format of a masking packet within the masking signal to be one of the group comprising: a lower order modulation format than the modulation format of the packet; and a modulation format randomly selected from a set of modulation formats. By setting the modulation format of a packet within the masking signal to be lower than that of one in the signal, the probability of a user outside the intended coverage region attempting to access data in the masking packet rather than in the data packet is increased. By selecting a modulation format randomly, it decreases the likelihood of a user outside the intended coverage region filtering out the masking packet through the modulation format being known.

The method may include the step of comparing the modulation format of the masking packet to the modulation format of the packet; and, if the modulation formats of the packet and the masking packet are the same, causing the strength of the masking signal to be greater than the strength of the signal. By increasing the strength of the masking signal when the modulation formats are the same the probability of a user outside the intended coverage region attempting to access data in the masking packet rather than in the data packet is increased.

Optionally, a beacon signal advertising access to the wireless network may be transmitted. This beacon signal encourages a user outside the intended coverage region of a wireless network who is attempting to gain access to data in the wireless network to transmit a response to the beacon signal in order to gain access to the wireless network in order that the user is known to the network. Advantageously, comprising the steps of receiving a response to the beacon signal and transmitting data to the sender of the response. Receipt of a response enables the method to be tailored in order that the user is less able to access data within the network, for example, dummy data may be sent directly to the user.

Advantageously, the method includes the steps of: determining the strength of a signal outside the intended coverage region, and setting the strength of the masking signal to be equal to or greater than the determined strength of the signal. By having an antenna outside the intended coverage region to receive signals it can readily be determined whether the properties of the masking signal provide sufficient masking to the data signal. For calibration, it is preferable that a randomised signal is sent as the signal and a masking signal is transmitted consecutively to the randomised signal. This allows the relative strengths of the signals to be easily determined without having to separate the signals which may not be easy.

Optionally, the method includes the steps of: determining the strength of an external signal transmitted by a device that is not in the wireless network, determining whether the strength of the external signal is above a threshold, transmitting a masking signal if the strength of the external signal is less than the threshold and not transmitting a masking signal if the strength of the masking signal is greater than the threshold. This enables signals transmitted by devices outside the wireless network to be used as masking signals enabling fewer masking signals to be transmitted and thereby decreasing the likelihood of a device outside the wireless network determining the properties of the masking signals and thereby being able to filter them out.

In accordance with another aspect of the present invention there is provided apparatus comprising: an input to receive a representation of a signal transmitted by a device within a wireless network; a controller to determine a property of the signal and, from the property, determine whether to transmit a masking signal; and an output to cause a masking signal to be transmitted, wherein the masking signal is transmitted outside the intended coverage region of the wireless network.

Preferably, the output is in communication with a directional antenna configured to transmit a masking signal outside the intended coverage region of the wireless network.

In accordance with a further aspect of the present invention there is provided a computer program embodied on a computer readable medium, the computer program configured to cause a controller to perform the steps of: determining a property of a signal transmitted by a device within a wireless network; determining, from the property, whether to transmit a masking signal; and upon determining to transmit a masking signal, transmitting a masking signal outside the intended coverage region of the wireless network.

In accordance with yet another aspect of the present invention there is provided a calibration sensor comprising: an input in communication with an antenna, the antenna being configured to receive a signal transmitted by a device in a wireless network and a masking signal; and a controller to detect the relative strengths of the signal and the masking signal such that the strength of the masking signal is increased if the strength of the masking signal is less than the strength of the signal. The calibration sensor enables a device responsible for masking signals transmitted by devices in a wireless network to ascertain whether the masking of the signals has been successful or not.

Optionally, the controller of the calibration sensor further comprises means of decoding the data within the signal such that the strength of the masking signal is increased if the controller decodes the data within the signal.

The calibration sensor may be configured to determine the strength of an external signal transmitted by a device that is not in the wireless network, determine whether the strength of the external signal is above a threshold such that a masking signal is transmitted if the strength of the external signal is less than the threshold and a masking signal is not transmitted if the strength of the masking signal is greater than the threshold.

### BRIEF DESCRIPTION OF THE DRAWINGS

Other aspects and features of the present invention will become apparent to those ordinarily skilled in the art upon review of the following description of specific embodiments of the invention in conjunction with the accompanying figures.

FIG. 1 illustrates apparatus of a first embodiment of the invention;

FIG. 2 illustrates a method implemented in the first embodiment of the invention;

FIG. 3 illustrates an alternative embodiment of the present invention including a calibration sensor; and

FIG. 4 illustrates a further embodiment of the invention including apparatus in communication with an external antenna.

### DETAILED DESCRIPTION OF PREFERRED EMBODIMENTS

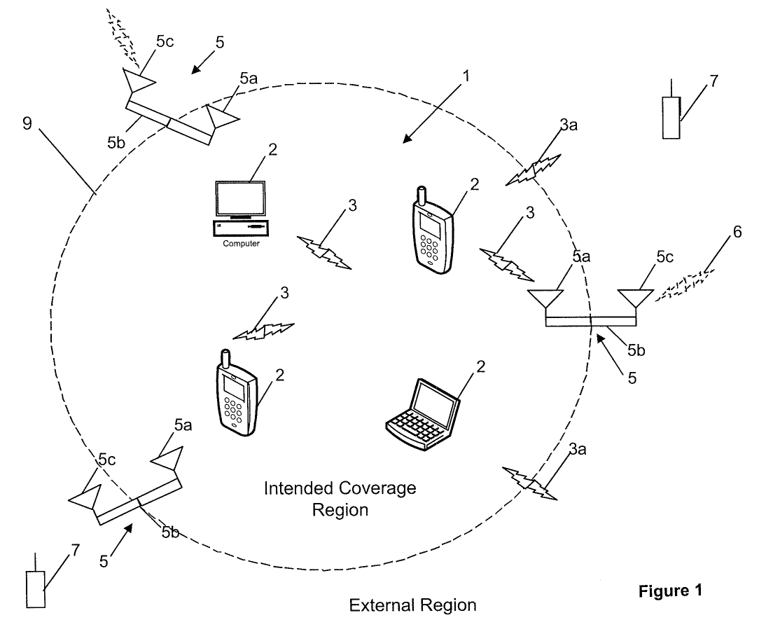

According to FIG. 1, a wireless communications network 1 has an intended coverage region which is defined by a parameter 9. The intended coverage region is a region within which devices 2 that are part of the wireless communications network 1 can be found. The intended coverage region may be, for example, an office, university campus or any other predefined region.

Within the wireless communications network 1 there are provided devices 2 for transmitting data signals 3 including data. These devices 2 may be, for example, an antenna, a cellular telephone, a personal computer or any other device. Additionally, apparatus 5, including an input antenna 5a, a controller 5b and an output antenna 5c, is provided at the periphery of the intended coverage region and transmits a masking signal 6 used to mask the content of the data signal 3.

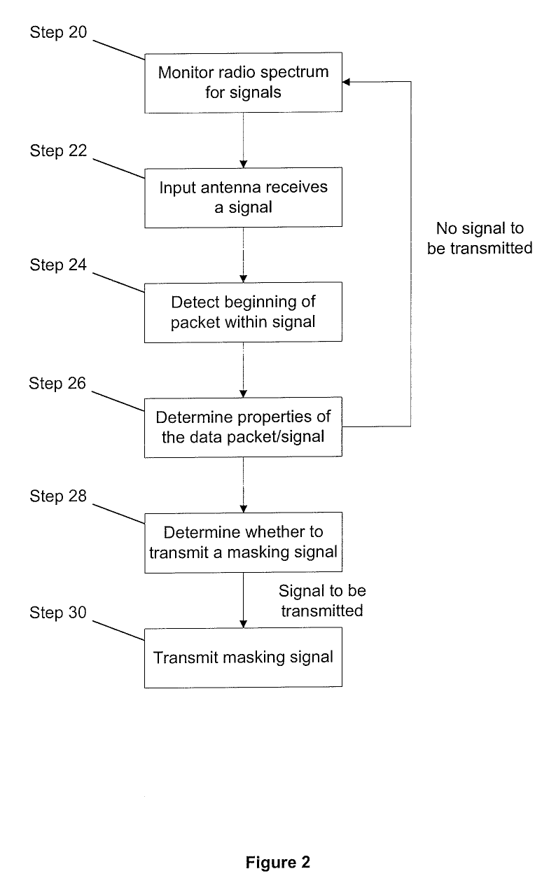

The method of the present invention will now be described with reference to FIGS. 1 and 2. The input antenna 5a of apparatus 5 monitors the radio spectrum for any signals (Step 20). When the input antenna 5a receives a signal 3 (Step 22) the apparatus 5 proceeds to monitor the signal 3 for the beginning of a data packet (Step 24). Upon detecting the beginning of a data packet 3a the controller 5b processes the signal 3.

The controller 5b determines properties of the data signal 3 and/or the data packet within the data signal 3 (Step 26). These properties may be any properties of the data signal 3 or data packet and may include, but are not limited to, the strength of the signal transmitting the data packet, the address of the sender of the data packet, the address of the receiver of the data packet, the type of data packet, the coding level of the data packet. Dependent upon these properties the controller 5b determines whether or not to transmit a masking signal 6 (Step 28).

If the controller 5b determines that no masking signal 6 is to be transmitted then no further action is taken and the controller 5b awaits the next signal.

If, however, the controller 5b determines that a masking signal 6 is to be transmitted, the controller 5b causes the output antenna 5c to transmit the masking signal 6 (Step 30). The output antenna 5c is positioned on the perimeter 9 of the intended coverage area and transmits masking signals away from the intended coverage region to minimise the chances of signals within the intended coverage region being masked.

The masking signal 6 interferes with the data signal 3. This means that a receiver 7 outside the intended coverage region will receive a combination of the masking signal 6 and the data signal 3 which appears as noise. Hence, the receiver 7 will ignore the combined signals and not access any data within the data signal 3.

It is desirable that, a masking signal 6 is not always transmitted in response to a data signal 3 being received by the internal antenna 5a. For example, if the data signal 3 has not been transmitted by the wireless network 1; the data signal 3 does not contain confidential information, for example it is an ACK message; or the data signal 3 has a strength which means that it will not be propagated outside the intended coverage region of the wireless network 1.

If a masking signal 6 is not to be transmitted automatically upon receiving a data signal 3 the controller 5b, upon receiving a representation of the signal 3, analyses the signal 3 and/or any data packets contained within the signal 3, to determine whether to transmit the masking signal 6.

The step of analysing a data packet may include, optionally, comparing the MAC address of the packet with MAC addresses known to be associated with the wireless communications network 1. If the MAC address of the packet is associated with the wireless communications network 1 then the controller 5b causes a masking signal 6 to be transmitted. However, if the MAC address is not associated with the wireless communication network 1 the controller 5b determines that the masking signal 6 is not to be transmitted. In this way only data packets transmitted by devices 2 within the wireless network 1 cause masking signals 6 to be transmitted.

MAC addresses for devices 2 within the wireless network 1 may be stored in a database, or any other suitable storage means, located in the controller 5b. Alternatively, the database may be located on a separate part of the apparatus 5 or on a remote device, such as a server (not shown), in communication with the apparatus 5.

Optionally, the controller 5b may determine from the MAC address of a packet within the data signal 3 the type of data packet that the packet is. If the controller 5b determines from the type of data packet that the data packet does not need to be masked, for example a the data packet is a short acknowledgement packet which will not contain any confidential information, then the controller 5b does not cause the masking signal 6 to be transmitted.

Types of messages for which no masking signal 6 is to be transmitted may be stored in a database, or any other suitable storage means, located in the controller 5b. Alternatively, the database may be located on a separate part of the apparatus 5 or on a remote device, such as a server (not shown), in communication with the apparatus 5.

The controller may determine whether to transmit a masking signal 6 by comparing the strength of the representation of the signal 3 to a threshold. The threshold is, for example, set at a level such that if the signal strength is below the threshold the signal is attenuated sufficiently over the distance between the input antenna 5a and the periphery of the intended coverage region that the signal strength is too weak for the signal 3 to be received by a receiver 7 outside the intended coverage region. Thus, if the controller 5b determines that the strength of data signal 3 is below the threshold no masking signal 6 is transmitted.

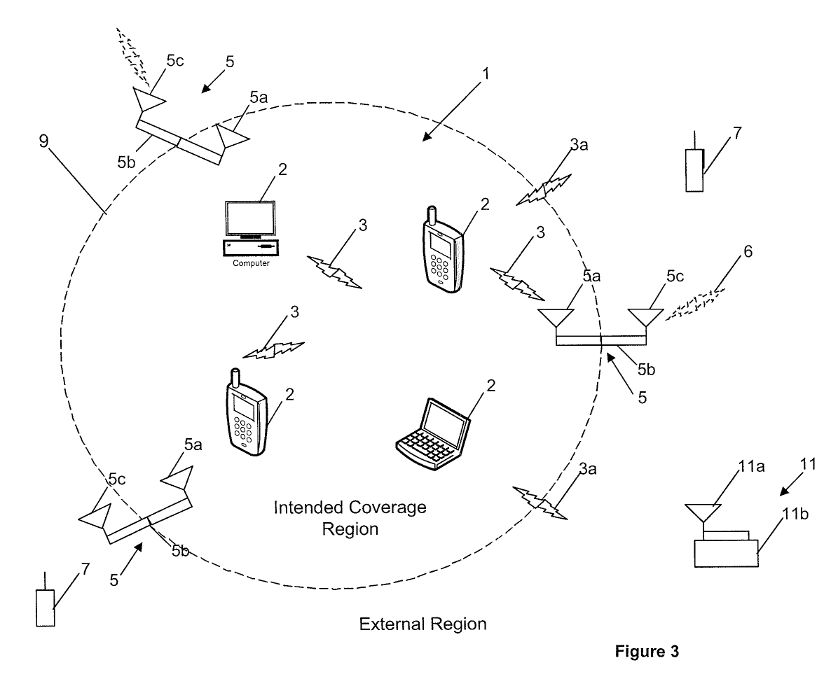

If, however, the strength of the data signal 3 is above the threshold, the controller 5b will cause a masking signal to be transmitted. This is because the strength of the data signal 3 is such that a receiver outside the intended coverage region of the wireless network 1 can receive the data signal 3 at a sufficient strength to extract data contained within the data signal. The threshold may be a predefined value set by a user of the wireless network. Alternatively, the threshold may be altered by calculations as described with reference to FIG. 3 below.

The controller may, optionally, vary properties of the masking signal 6 dependent upon the properties of the data packet or data signal. For example, the controller 5b may determine the frequencies over which the data signal 3 is transmitted. The controller 5b will then cause the masking signal 6 to be transmitted over substantially the same range of frequencies as the data signal 3. The range of frequencies of the masking signal 6 is preferably substantially equal to that of the data signal 3 in order to ensure that the whole of the data signal is masked effectively. In this way only the frequency range of the data signal is subject to a masking signal 6. This means that devices 7 outside the intended coverage region can transmit and receive data on frequencies other than that used by the wireless network 1 without the masking signal 6 masking the data transmission.

The controller 5b may detect a header in the MAC address of a data packet within the data signal 3. The controller 5b decodes the length field of the header to determine the length of the data packet. From the determined length of the data packet the duration of the transmission of a data signal 3 including the data packet can be determined. The controller 5b can then determine a time period over which the masking signal 6 should be transmitted in order that the masking signal 6 transmission time and the transmission time of the data signal 3 are substantially the same. This means that devices outside the intended coverage region can use the frequency used for data transmission by the wireless network 1 outside the time periods that the wireless network 1 is transmitting data without a masking signal 6 interfering with their data transmissions.

The controller 5b may determine the modulation format and/or the coding rate of a data packet contained within the data signal 3. From the determined modulation format and/or coding rate the controller 5b can select a modulation format and/or coding rate for a masking packet (not shown) to be transmitted within a masking signal 6.

The selected modulation format for the masking packet is preferably a lower modulation format than that of the data packet. This is based on the assumption that a receiver 7 will attempt to decode packets with a simpler modulation format and will therefore attempt to decode the masking packet in preference to the data packet.

The selected coding rate of the masking packet is preferably a lower rate than that of the data packet. This is based on the assumption that a receiver will attempt to decode a packet with a lower coding rate in preference to a packet with a higher coding rate and thus will attempt to decode the masking packet in preference to the data packet.

The controller 5b sets the header of the masking packet to indicate the selected modulation format and coding rate and then transmits the masking packet. Optionally, the controller 5b may change the modulation format and coding rate of the masking packet in a random or pseudo-random way. This prevents users 7 outside the intended coverage region easily compensating for the presence of the masking signal 6.

The controller 5b may also vary the strength of the masking signal 6 with reference to the strength of the data signal 3 in order that the strength of the masking signal is greater than that of the data signal outside the intended coverage region. Preferably, the strength of the masking signal 6 is 20 to 30 dB greater than that of the data signal 3.

Optionally, the strength of the masking signal may also be varied with reference to one or more of the modulation format and coding rate of the data packet 3a as different modulation formats can be successfully decoded at different signal to noise ratios. For example, QPSK can be demodulated successfully at a lower signal to noise ratio than 16 QAM. This variation may be achieved, for example, by providing the apparatus 5 with a table associating a modulation format of the data signal 3 with a minimum strength for transmission of the masking signal.

The controller 5b may determine the properties of the data signal and the masking signal. Alternatively, one or more of the above-described functions may be performed on one or more separate components. The separate components may be integral to the apparatus 5 or located on devices (not shown) remote from and in communication with the apparatus 5.

Optionally, the controller 5b may be enabled to cause the output antenna 5c to transmit a beacon signal to advertise the wireless communications network 1 as a network access service. If a receiver 7 outside the intended coverage region 9 transmits a response to the beacon signal, in order to gain access to the wireless communications network 1, the controller 5b receives the response and records the MAC address of the receiver 7 outside the intended coverage region 9. The controller 5b can then cause the output antenna 5c to transmit a masking signal 6 containing masking packets including the MAC address of the receiver 7 outside the intended coverage region 9. This means that the receiver will attempt to decode the masking packet 6a in preference to the data packet 3a.

In addition, the masking signal 6 could provide information that enables the receiver 7 to access a dummy database populated with dummy information. This will cause the receiver 7 to access the information rather than intercept further data signals 3 transmitted by devices 2 within the wireless network 1.

The wireless network 1 may be set up using only a single apparatus 5 at the periphery 9 of the intended coverage region. Alternatively, a plurality of apparatus 5 may be positioned around the periphery of the intended coverage region 9. In a further optional arrangement, a plurality of input antennas 5a and output antennas 5c are positioned about the periphery of the intended coverage region 9 and one controller 5b is associated with two or more antennas 5a, 5c. This has the advantage of transmitting masking signals 6 to a greater region outside the intended coverage region than by just using one apparatus 5.

Additionally, as will be recognised by one skilled in the art one antenna may perform the functions of both the input and output antennas.

Optionally, the apparatus 5 may transmit two or more masking signals 6 simultaneously. Preferably, each masking signal has one or more of different data, a different modulation and a different coding format. This decreases further the likelihood of a user 7 outside the intended coverage region accessing data in the data signal 3 as the user 7 will need to resynchronise its symbol timing for each masking signal and it also prevents the user 7 from anticipating a constant masking signal 6 and therefore compensating for its presence.

FIG. 3 illustrates an alternative embodiment of the present invention. The alternative embodiment includes the network components described above, namely devices 2 within a wireless network 1 and at least one apparatus 5 including an internal antenna 5a, controller 5b and external antenna 5c. In addition to the devices previously described, with reference to FIGS. 1 and 2, the wireless network 1 is also provided with a calibration sensor 11 at a point outside the intended coverage region 9. The calibration sensor 11 includes an antenna 11a for receiving signals and a calibration controller 11b to measure the strengths of received signals.

In use, the calibration sensor 11 receives a signal 3 and the masking signal 6 at the antenna 11a. The controller 11b analyses both the data signal 3 and the masking signal 6 to measure their strengths.

The controller 11b transmits the measured strength of the signals to the apparatus 5 by any suitable means. For example, the controller may transmit the strengths using a second antenna (not shown) or, alternatively, using a wired connection between the calibration sensor 11 and apparatus 5 (not shown).

The apparatus 5 can then determine, from the relative strengths of the signals, whether the masking signal 6 masks the data signal 3 sufficiently. If the masking is not sufficient then the apparatus 5 increases the strength of the masking signal to improve masking.

For calibration, it is preferable that the data signal 3 is a test data signal which only includes randomised data or dummy data and the masking signal 6 is transmitted after or before the data signal. This means that the calibration sensor 11 is able to accurately separate the strengths of the data signal and the masking signal which would not be possible if the signals were overlaid in time.

The controller 11b may, in addition to, or instead of, measuring the relative strengths of received signals, attempt to decode the data contained within data signals 3. If the controller 11b is successful in decoding the data in the data signal 3, it reports the success to the apparatus 5 using any suitable means such as those described above. The apparatus 5 then uses this information in further calculations of the properties of the masking signal 6, for example, by increasing the strength of the masking signal 6 compared to the signal 3 or decreasing the threshold that the controller 5b uses to determine whether to transmit a masking signal 6.

Optionally, the calibration sensor 11 may also receive signals transmitted by devices which are not part of the wireless network 1, hereinafter referred to as external signals. In response to receiving a signal, the calibration sensor 11 determines, for example using the MAC address of a packet within the signal, whether the signal has been transmitted by a device that is part of the wireless network 1 or is an external signal. If the signal is an external signal then the calibration sensor 11 may communicate with the apparatus 5 so that no masking signal is transmitted. This is because any data signals being transmitted by devices within the wireless network will be masked by the external data signals occupying the radio frequency upon which the wireless network's signals are sent.

If desired the calibration sensor 11 may monitor the strength of the external signals and, if the strength of the external signal is greater than a threshold, cause the apparatus not to send a masking signal. If the strength of the external signal is less than a threshold then the apparatus transmits a masking signal; this is because the strength of the external signal is insufficient to mask the signal transmitted by a device within the wireless network. Alternatively, the calibration sensor 11 may transmit a measurement of the strength of the external signal to the apparatus 5 which determines whether to transmit a masking signal from the indicated strength.

Preferably, if external signals are being used to mask data signals transmitted by devices in the wireless network the MAC addresses of the external packets and the pattern of transmissions is monitored. This may include monitoring the external signals for corresponding ACK packets. This is done to ensure that a user 7 does not transmit external signals to cause non-transmission of masking signals. As, if a user did transmit these external signals, they would be able to access data within signals transmitted by the wireless network due to the lack of a masking signal.

As will be understood by one skilled in the art the wireless network 1 may be set up using only a single apparatus 5 at the periphery 9 of the intended coverage region. Alternatively, a plurality of apparatus 5 may be positioned around the periphery of the intended coverage region 9. In a further optional arrangement, a plurality of input antennas 5a and output antennas 5c are positioned about the periphery of the intended coverage region 9 and one controller 5b is associated with two or more antennas 5a, 5c. This has the advantage of transmitting masking signals 6 to a greater region outside the intended coverage region than by just using one apparatus 5.

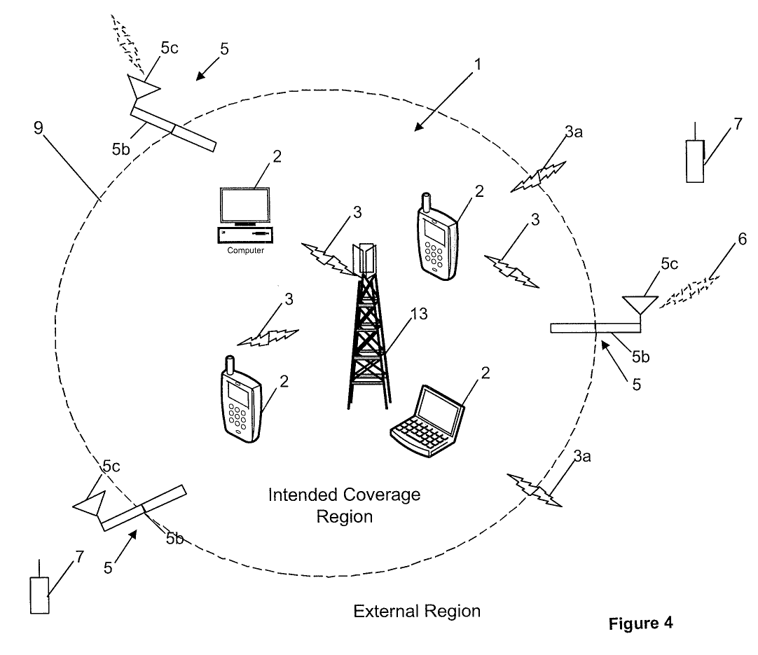

FIG. 4 illustrates a further alternative embodiment, of the present invention. The alternative embodiment includes the network components described above with reference to FIG. 1 except that the apparatus 5 includes an input (not shown), controller 5b and output antenna 5c. The input is configured to receive data from an external antenna 13 positioned within the wireless communications network 1, the external antenna 13 is arranged to receive signals. Upon receiving a signal the external antenna 13 transmits a representation of a signal 6 to the controller 5b. The controller 5b, then causes the output antenna 5c to transmit a masking signal 6. The controller 5b may incorporate any or all of the features of the controller 5b described above, and hence, perform calculations with reference to the signal 3 and the packet to determine properties for a masking signal 6 and a masking packet.

Alternatively, the input may be configured to receive data about a transmitted signal from one or more nodes in the wireless network. In this way nodes can send the apparatus 5 information regarding signals they have transmitted across the wireless network.

The apparatus 5 or controller 5b may be collocated or integral to one or more network access points in the wireless network. In this instance, the network access point, or controller, is in communication with a plurality of internal antennas and external antennas positioned about the periphery of the intended coverage region 9. The internal antennas being arranged to transmit data packets into the intended coverage region and the external antennas being arranged to transmit masking packets outside the intended coverage region.

Each of these network access points may be associated with two or more antennas in order to achieve the desired effect. Collocating the apparatus or controller with a network access point has the advantage that it is not necessary for the apparatus or controller to sense the presence of a data packet as packet timing is known by the access point and can be used directly to trigger the transmission of the masking packet.

Optionally, in any of the embodiments described above, the wireless communication network 1 may encrypt the signal 3 in addition to transmitting a masking signal. This would give further reduction in the probability of the receiver 7 outside the intended coverage region decoding the data within a signal.

The masking signal 6 may be a randomised data which may, or may not be divided into one or a plurality of masking packets (not shown). The randomised data may, for example, be generated using a pseudo-random sequence generator or any other suitable means. Alternatively, as described above, the masking signal 6 may include data that a device 7 outside the intended coverage region can access, such as dummy data allowing access to a database populated with dummy information. The dummy data and antenna to transmit the dummy data ma be integral to the apparatus 5. Alternatively, one or more of the devices used to provide the dummy data and transmissions may be located remotely from the apparatus. The devices are also able to receive signals from an external user and, if appropriate respond to those signals.

Preferably the output antenna 5c has a good front to back ratio, for example a ratio of more than 10 dB.

What is claimed is:

1. A method of masking a signal outside an intended coverage region of a wireless network, the signal being transmitted by a device within the wireless network, the method comprising the steps of,
a) determining a property of the signal;
b) determining, from the property, whether to transmit a masking signal; and
c) upon determining to transmit a masking signal, transmitting a masking signal outside the intended coverage region.

2. The method as claimed in claim 1, wherein the step of determining a property of the signal comprises determining if the signal was transmitted by a device within the wireless network and the method comprises transmitting a masking signal if the device is in the wireless network.

3. The method as claimed in claim 2, wherein the step of determining if the signal was transmitted by a device in the wireless network comprises the step of determining the MAC address of a packet in the signal and comparing the determined MAC address to the MAC addresses of devices in the network.

4. The method as claimed in claim 1, wherein the step of determining a property of the signal comprises determining if the type of packet within the signal and the step of determining, from the property, whether to transmit a masking signal comprises determining whether the type of packet is to be masked.

5. The method as claimed in claim 1, wherein the step of determining a property of the signal comprises determining the strength of the signal and the step of determining if masking signal is to be transmitted comprises the step of comparing the strength of the signal to a threshold; the masking signal being transmitted if the strength of the signal is above the threshold.

6. The method as claimed in claim 1, further including the step of determining the strength of the signal and setting the strength of the masking signal to be greater than that of the signal.

7. The method as claimed in claim 1, wherein the masking signal is transmitted in a frequency range such that the frequency range of the masking signal substantially overlaps with the frequency range of the signal.

8. The method as claimed in claim 1, wherein the masking signal is transmitted for a time duration such that the time duration of the masking signal substantially overlaps with the time duration of the transmission of the signal.

9. The method as claimed in claim 8 further comprising the steps of detecting a header of a packet within the signal, determining the length of the packet from the header and causing a packet within the masking signal to have a corresponding length to the packet within the signal.

10. The method as claimed in claim 1, further including the steps of: determining the coding rate of a packet within the signal and setting the coding rate of a masking packet within the masking signal to be one of the group comprising:
a lower coding rate than the coding rate of the packet; and
a coding rate randomly selected from a set of coding rates.

11. The method as claimed in claim 10, further comprising the step of comparing the coding rate of the masking packet to the coding rate of the packet; and, if the coding rates of the packet and the masking packet are the same, causing the strength of the masking signal to be greater than the strength of the signal

12. The method as claimed in claim 1, further including the steps of: determining the modulation format of a packet within the signal and setting modulation format of a masking packet within the masking signal to be one of the group comprising:
a lower order modulation format than the modulation format of the packet; and
a modulation format randomly selected from a set of modulation formats.

13. The method as claimed in claim 12, further comprising the step of comparing the modulation format of the masking packet to the modulation format of the packet; and, if the modulation formats of the packet and the masking packet are the same, causing the strength of the masking signal to be greater than the strength of the signal.

14. The method as claimed in claim 1 further comprising causing a beacon signal advertising access to the wireless network to be transmitted.

15. The method as claimed in claim 14 further comprising the steps of receiving a response to the beacon signal and transmitting data to the sender of the response.

16. The method as claimed in claim 1 further including the steps of: determining the strength of a signal outside the intended coverage region, and setting the strength of the masking signal to be equal or greater to the determined strength of the signal.

17. The method as claimed in claim 16 further including the steps of transmitting a randomised signal as the signal and a masking signal consecutively, determining their relative strengths and, if the strength of the masking signal is less than the strength of the signal increasing the strength of the masking signal.

18. The method as claimed in claim 1 further including the steps of: determining the strength of an external signal transmitted by a device that is not in the wireless network, determining whether the strength of the external signal is above a threshold, transmitting a masking signal if the strength of the external signal is less than the threshold and not transmitting a masking signal if the strength of the masking signal is greater than the threshold.

19. Apparatus comprising:
an input to receive a representation of a signal transmitted by a device within a wireless network;
a controller to determine a property of the signal and, from the property, determine whether to transmit a masking signal; and
an output to cause a masking signal to be transmitted, wherein the masking signal is transmitted outside the intended coverage region of the wireless network.

20. Apparatus as claimed in claim 19 wherein the output is in communication with a directional antenna configured to transmit a masking signal outside the intended coverage region of the wireless network.

21. A computer program embodied on a computer readable medium, the computer program configured to cause a controller to perform the steps of:
a) determining a property of a signal transmitted by a device within a wireless network;
b) determining, from the property, whether to transmit a masking signal; and
c) upon determining to transmit a masking signal, transmitting a masking signal outside the intended coverage region of the wireless network.

22. A calibration sensor comprising,
a) an input in communication with an antenna, the antenna being configured to receive a signal transmitted by a device in a wireless network and a masking signal; and
b) a controller to detect the relative strengths of the signal and the masking signal such that the strength of the masking signal is increased if the strength of the masking signal is less than the strength of the signal.

23. The calibration sensor as claimed in claim 22, wherein the controller further comprises means of decoding the data within the signal such that the strength of the masking signal is increased if the controller decodes the data within the signal.

24. The method as claimed in claim 22 wherein the calibration sensor is further configured to determine the strength of an external signal transmitted by a device that is not in the wireless network, determine whether the strength of the external signal is above a threshold such that a masking signal is transmitted if the strength of the external signal is less than the threshold and a masking signal is not transmitted if the strength of the masking signal is greater than the threshold.
